(19) United States
(12) Patent Application Publication
(10) Pub. No.: US 2013/0262479 A1
(43) Pub. Date: Oct. 3, 2013

(54) POINTS OF INTEREST (POI) RANKING BASED ON MOBILE USER RELATED DATA

(71) Applicants: Sam Song Liang, Palo Alto, CA (US); Jun Yang, Milpitas, CA (US); Chenyu Wang, Mountain View, CA (US); Yun Fu, Cupertino, CA (US)

(72) Inventors: Sam Song Liang, Palo Alto, CA (US); Jun Yang, Milpitas, CA (US); Chenyu Wang, Mountain View, CA (US); Yun Fu, Cupertino, CA (US)

(73) Assignee: ALOHAR MOBILE INC., Palo Alto, CA (US)

(21) Appl. No.: 13/907,865

(22) Filed: Jun. 1, 2013

Related U.S. Application Data
(63) Continuation-in-part of application No. 13/269,577, filed on Oct. 8, 2011.
(60) Provisional application No. 61/654,896, filed on Jun. 3, 2012.

(51) Int. Cl. G06F 17/30

(52) U.S. Cl. CPC G06F 17/3053
USPC 707/748

(57) ABSTRACT

Methods, systems and apparatus for ranking potential points of interest (POIs) of a user stay are disclosed. One system includes an upstream server connected through a network to a mobile device. At least one of the upstream server and a controller of the mobile device is operative to estimate a location of a user stay of the mobile device, access a database of POIs, and parameters of the POIs, and generate a ranking score for a plurality of POIs based on a weighted comparison of each of the parameters of the POIs with corresponding parameters of the user stay.

### RELATED APPLICATIONS

This patent application claims priority to U.S. Provisional Patent Application No. 61/654,896, filed Jun. 3, 2012, and is a continuation-in-part of U.S. patent application Ser. No. 13/269,577, titled “DETERMINING POINTS OF INTEREST OF A MOBILE USER”, filed Oct. 8, 2011, which claims priority to U.S. Provisional Patent Application Ser. No. 61/406,198 filed Oct. 25, 2010, which are herein all incorporated by reference.

### FIELD OF THE DESCRIBED EMBODIMENTS

The described embodiments relate generally to location-based services. More particularly, the described embodiments relate to methods, systems and apparatuses for ranking points of interest based on mobile user related date.

### BACKGROUND

There is an increasing need to automatically monitor a mobile device user's location and other behavior, understand the user's habits and interests, and provide intelligent personal assistance to the user based on the user's habits and interests obtained through location based behavior analysis. Presently, location based services include manual check-ins. For a manual check-in, the user opens an application on their mobile device manually, and indicates that they are at a specific business.

In the area of location-based services, a check-in represents a single visit by a user to a location or place on the earth. One of the main problems with checking in is check-in fatigue. The fact that most popular social networks require users to manually enter their location makes them pretty tedious considering there is often little to no reward. FourSquare, Facebook or Google Latitude have developed check-in technology based on geo-fencing and background location monitoring that can trigger some interesting applications by getting close. However, this type of solution is not generative, which require users to input his favorite places into the system in advance. It cannot be applied to a new place that is not in the scope of existing places database of the user.

Additionally, location-based searches are manual. That is, the user conducts a search of some business using keyword, such as “restaurant”, and the application returns results that are the closest to the user's current location.

Other location-based service includes mobile social applications wherein, for example, friends are shown on a map. However, that services and applications are limited because they can't accurately determine the point of the interest the user is at, hard to disambiguate between multiple points of interest near each other. Generally, current local business or POI search is only using the spatial data as input, which does not generally provide enough information to accurately determine the point of interest.

It is desirable to have a method, apparatus and system for ranking points of interest based on mobile user related date.

### SUMMARY

An embodiment includes a system for ranking potential points of interest (POIs) of a user stay. The system includes an upstream server connected through a network to a mobile device. At least one of the upstream server and a controller of the mobile device is operative to estimate a location of a user stay of the mobile device, access a database of POIs, and parameters of the POIs, and generate a ranking score for a plurality of POIs based on a weighted comparison of each of the parameters of the POIs with corresponding parameters of the user stay.

Another embodiment includes a method of ranking potential points of interest (POIs) of a user stay. The method includes estimating a location of a user stay, accessing a database of POIs, and parameters of the POIs, and generating a ranking score for a plurality of POIs based on a weighted comparison of each of the parameters of the POIs with corresponding parameters of the user stay.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an example of a map that depicts locations traveled by an individual that further depicts points of interest of the user.

FIG. 2 shows an example of a mobile device that the disclosed embodiments for determining user stays of the user of the mobile device are operable, according to an embodiment.

FIG. 3 is a table that shows a mapping of all POI categories category classes based on properties of the POIs, wherein a POI mapping ID is assigned to each POI category, according to an embodiment.

FIG. 4 shows a time-line of locations of the mobile device, which can be used for determining user stays of the user of the mobile device, according to an embodiment.

FIG. 5 shows a time-line of user stays of the mobile device, which can be used for providing services to the user of the mobile device, according to an embodiment.

FIG. 6A shows a time sequence of location data points that are used to identify a user stay, according to an embodiment.

FIG. 6B shows a spatial and temporal representation of the location points, according to an embodiment.

FIG. 7 is a flow chart that includes steps of an example of a computer-implemented method of real-time determination of user stays of a mobile device, according to an embodiment.

FIG. 8 is a flow chart that includes steps of a continuous place detection engine using location data of a mobile device of a user, according to an embodiment.

FIG. 9 is a flow chart that includes steps of continuous user stay refinement processing, according to an embodiment.

FIG. 10 is a flow chart that includes steps of a method of place detection, according to an embodiment.

FIG. 11 is a flow chart that includes steps of a method ranking points of interest based on mobile user related date, according to an embodiment.

### DETAILED DESCRIPTION

The described embodiments include methods, systems and apparatuses for computing a relevant ranking score of mobile user's POIs based on user related mobile location data. The ranking scores can be used to determine user potentially visited POI with certain confidence level.

The described embodiments provide rankings of the mobile user's potentially visited places based on ambient POI ranking processing. The described embodiments use the mobile user's context data and various sensor information to estimate user's potential visited places in a personalized ranking format, which can be used as a cloud service for building mobile user's location preference and enabling lots of emerging mobile location based services. Further, at least some of the embodiments for ranking include a derivative formula to aggregate multi-modal context data available on mobile devices and rank potential POIs, such as physical distance, address distance, motion pattern correlation, time heuristic correlation, personal places, place visits, user context information, place category heuristic and place popularity.

The described embodiments advantageously include sequential processing with linear computational complexity, which can be used as a continuous running engine in, for example, the cloud for quickly mining large GPS (or other location) data set from millions of mobile users. Processing of the described embodiments can be developed as a client-side incremental location sensing engine. Further, at least some embodiments include processing of location (such as, GPS) data by continuously calculating location centroids and clustering a potential user stay out of input data stream at the same time, and then merging the current user stay with previously discovered user stays if possible. At least some of the described embodiments use network location points to help clustering and improve the time interval estimation of user stay. Further, processing of at least some of the described embodiments include coarse location processing to detect a user's places at large scale, and then repeating with finer location processing to extract a detailed user places at a small scale. The same clustering methods can be used to do sub-clustering in a successive approach. This property greatly matches user's location habits and interests from a geographical point of view, usually from big regions to small places.

Some existing systems require and leverage a user input. Such systems give a user an incentive to register a place name on their mobile software every time the user enters a place of interest or significance. That is, the existing systems are relatively primitive and require a user input specifying the time when the user stayed at a place or what that place is, or both. In contrast, the described embodiments do not require a user input and, for the most part, automatically detect the fact that the user stayed proximate to a location (for at least some embodiments, the coupling proximity, time and place is referred to as a “user stay”). That is, at least some embodiments include determining a user stay without real-time input by the user of the mobile device. That is, any user inputs are displaced from the time and place at which the user stay is being determined, or the time and place at which the user inputs are received do not influence the user stay determination.

For at least some embodiments, a user stay of a user of the mobile device is defined by the mobile device being within the specific distance (which for at least some embodiments, is determined by a threshold physical distance) of a location for at least the specific minimal duration (which can also be defined by a threshold period of time). As described, the location of the mobile device changes over time, and the specific location changes over time as the locations of the mobile changes. The location of the mobile device is tracked over time. A distance of the mobile device can be defined by the distance of each location point (such as, GPS data point) associated with the mobile device to a location, such as, the specific location. The minimal time duration can be defined by the amount of time the mobile device is within the specific distance (or threshold distance) from the specific location.

As previously stated, for at least some embodiments, the specific location adaptively changes over time as the mobile device moves. At least some embodiments include determining the specific location by statistically calculating the specific location based on a plurality of locations of the mobile device over a period of time. For an embodiment, the period of time is determined based on the start time and the end time. As will be described, the statistical calculation can include the determination of a centroid.

An embodiment includes associating a Point of Interest (POI) with the specific location, and adaptively determining the specific distance based on the POI. An embodiment includes adaptively determining the specific minimum time duration based on the POI. For an embodiment, at least one of the specific distance or the specific minimum time duration is determined by accessing a look up table based on the POI.

For at least some embodiments, the POI is defined as a specific point location or place that someone may find useful or interesting. There can be at least two types of POIs: public POIs (e.g. stores, parks) that one can obtain from POI database services, and personal POIs (e.g. home, friend's home) that are personal to a mobile user. As described, the specific distance and the specific minimum time duration can adaptively change based on an identified POI associated with the user stay. For example, the specific distance and the specific minimum time duration associated with a physically large POI (such as, a convention hall or sports stadium) can be quite different than the specific distance and the specific minimum time duration associated with physically small POI (such as, a small shop or residence).

A POI can have several properties, such as latitude and longitude, a name (e.g., Olive Garden), a category (for instance, restaurant), and a subcategory (for example, Italian cuisine). A POI can be of different sizes, and can have a hierarchical structure. For example, a POI can be a big park, such as Yosemite. Inside the park, there can be smaller POIs, such as a hotel or a restaurant. Furthermore, a POI can be associated with an event name (for example, a concert of Beatles, or a baseball game in a stadium, a seminar on cooking).

For at least some of the embodiments described, a user stay is defined as an event in which a specific user visits a specific POI at a specific time. For embodiments, each user stay has attributes including reference to the POI, start time of the visit, duration of the visit, and the device (as a proxy of the user) that detects the visit. A user stay can be detected by clustering user location data continuously collected by the mobile device of a user, computing the cluster's centroid, and then matching it to a nearby POI. In addition to its geographical presence, a user stay can include temporal presence, such as events scheduled at the specific POI. For example, the POI like a stadium can have football game on Friday, a concert on Saturday, and a baseball game on Sunday. For at least some embodiments, such an event is defined as an event of interest (EOI), which can be an attribute of a user stay.

For at least some embodiments, the determinations of user stays and the user's points of interest are automatic. That is, user stay and/or POI determination processing is automatically executed without the user proactively or reactively providing input. For some embodiments, the determination of the user's user stays and/or POIs does not require manual input from the user. The processing can be performed in the background, and operate on persistently collected sensor data (optionally uploading the data to a server). For an embodiment, a background-processing algorithm determines the user stay and/or POI. Note, all or portions of the user stay and/or POI determination algorithms can run on both mobile client side (the mobile device) and server side (a server connected to the mobile device through a network). Other embodiments include semi-automatic processing in which a user's input or feedback can optionally be included with the processing to improve the process. For example, user inputs, such as correcting or adding or deleting a user stay and/or POI, can be used as important feedback information to boost the performance of overall user stay and/or POI determination processing.

For some embodiments, the processing is performed (at the mobile device and/or at the server) in real-time, and for some embodiments the processing includes post-processing. For real-time processing, the user stay and/or POI determination is made with a short delay (e.g. 10 seconds or a minute) after the user arrives at the user stay and/or POI, with a determination deadline being adaptively specified depending on the application. For post-processing, the user stay and/or POI determination is made beyond the short delay (or without a deadline).

For at least some embodiments, a current state of a user is defined as the user's current location, time and what the user is doing. Furthermore, the current state can include user stays of that user within a predetermined time window before a present time, wherein the predetermined time window has variable length dependent upon application requirements and the location behavior being observes. For example, the time window of current state can be past few seconds, past hour, this morning (or afternoon), today, this week, or this month etc. As a result, the location of current state can be the POI (e.g. a restaurant) the user is staying right now if the time window is a few seconds or a larger area (e.g. San Francisco) in case the time window is past few days.

Embodiments include tracking user stays of the user over time, wherein the user stays include at least one location and creating a user profile for the user based at least in part on at least one of an arrival time, a duration or a frequency of visits of the user at each of the user stays. For at least some embodiments, the user profile is defined as the results of location based user behavior analysis. For at least some embodiments, the user profile includes the fundamental statistics, such as the number of visits, the time of visit, and the average and total duration of all visits to one POI. Furthermore, for at least some embodiments the user profile includes location behavior patterns learned from the fundamental statistics. For example, it includes user's location preference, such as which POIs or EOIs a user visits often, at what time of the day and/or day of week, user's location transitions between different POIs, and user preferred routes between POIs according to trail information. For example, the statistical transitions can include one-step location behavior change, such as the user visiting place A after place B, or multi-step location behavior change, visiting place A after place B and then going to place C. In addition, for at least some embodiments, the user profile includes user manually input preferences. The user profile includes characteristics of the user. One characteristic of the user includes a history of locations of interest of the user. For at least some embodiments, the user profile includes the statistics of the categories and subcategories of the POIs and EOIs the user has visited.

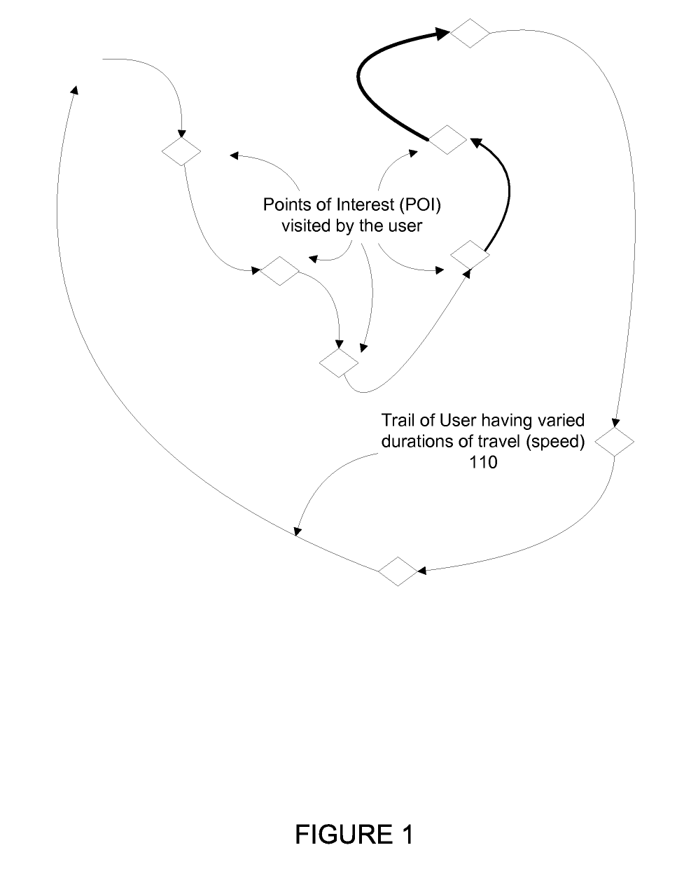

FIG. 1 shows an example of a map that depicts locations traveled by an individual that further depicts points of interest (or user stays). A line 110 depicts the locations traveled by the user. During the travels of the user, the user visits various points of interest. Based on the visited locations, additional points of interest can be recommended and/or suggested to the user. The locations traveled and the time spent at or between locations can be used to identify user stays of the user.

The trail of the user can be marked by differing speeds (depicted by varying thickness of the line 110) of travel between points of interest. The travel speed can be used as one piece of information in the determination of trails of interest.

A series of points of interest (such as shown in FIG. 1) can be termed a “trail of interest”. The trail of interest includes a sequence of location data points. Embodiments of each location data point can include the attributes of latitude, longitude, altitude, speed and/or a timestamp. More specifically, an embodiment of a trail of interest is defined by a plurality of points of interest of the user. For an embodiment, a frequency and/or speed of the user between points of interest is used to determine a level of importance of the trail. For example, if a user travels along one part of a trail (or route) frequently, with low speed (meaning it is a local street, rather than high way, which can be verified by using a geo-database), then some types of services along the this part of the trail can be recommended to the user, with the expectation that it is more likely for the user to use the service, because it is easier for the user to stop by the service. For an embodiment, the level of importance is included within a user profile.

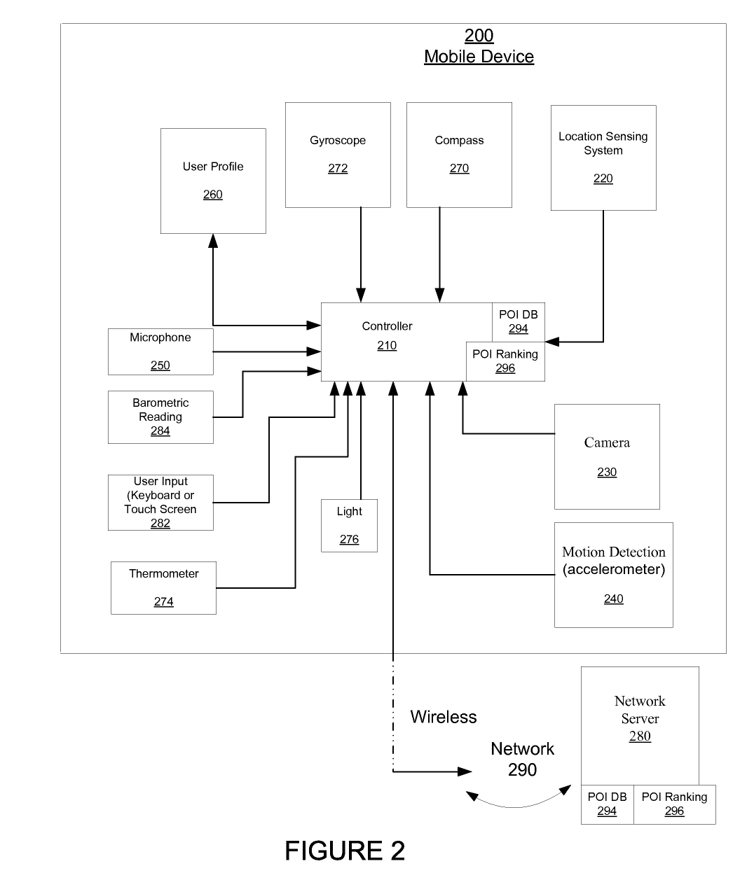

FIG. 2 shows an example of a mobile device that the disclosed embodiments for determining user stays and ranking potential points of interest (POIs) of the user of the mobile device are operable, according to an embodiment. For embodiments, user location data is continuously collected from the mobile device over time. The data can consist of multiple streams of sensor data with timestamps.

Spatial information (such as, longitude, latitude, altitude) of the user can be determined by a location sensing system, such as a global positioning system (GPS), 220 and/or network-based location, such as location determined by cellular and/or WiFi networks of the mobile device 200. Based on the spatial information, a controller 210 (or another controller connected to the controller 210) of the mobile device 200 can roughly determine locations of the user. GPS, however, can be limited because the exact location or the actual business (point of interest) visited by the user may not determinable from GPS alone. Embodiments provide alternate or additional pieces of location information as determined by the controller 210, or a controller electronically connectable to the controller 210.

The controller 210 has access to a POI database 294 that effectively includes a list of possible POIs that can be matched to user stays of the user of the mobile device. A ranking engine 296 of the controller 210 ranks the POIs for each user stay. Based on the ranking, an estimate of the POI of each user stay can be made. It is to be understood that while the POI database 294 and the ranking engine 296 are shown as a part of the controller 210, the POI database 294 and the ranking engine 296 can easily be located within a network connected to the upstream server 280. That is, the POI database 294 and the ranking engine 296 can be located elsewhere.

As shown, the system for ranking potential points of interest (POIs) of a user stay includes the upstream server 280 connected through a network 290 to the mobile device 200. For at least some embodiments, at least one of the upstream server 280 and the controller 210 of the mobile device 200 is operative to estimate a location of a user stay of the mobile device, access the database of POIs 294 (wherein the database 294 additionally includes parameters of the POIs), and generate a ranking score for a plurality of POIs based on a weighted comparison of each of the parameters of the POIs with corresponding parameters of the user stay.

For example, a user may go to a cafe (e.g. Starbucks®). The system (mobile device and/or upstream server) identifies the user stay, which is identified, for example, by the start time, the end time, and the location. The system (mobile device and/or upstream server) queries the database of POIs by the location. It may return a list of nearby POIs, which include the café, a grocery store, a postal office, etc. The system (mobile device and/or upstream server) further generates a ranking score for each POI. For at least some embodiments, the ranking score is initially set by the distance of the POI to the user stay. For at least some embodiments, the smaller distance, the better (lower) the score. For at least some embodiments, the system further adjusts the score based on factors such as address edit distance, the timing of the user stay, the motion of the user stay, the popularity of the POI, etc. For an embodiment, if the system (mobile device and/or upstream server) favors a POI, the system makes the score smaller. For an embodiment, if the system does not favor a POI, the system makes the score larger.

For an embodiment, at least one of the upstream server and the controller of the mobile device is further operative to match the user stay with a POI based on the rankings of the potential POIs with an estimated confidence level of the matching.

For at least some embodiments, the confidence level is an indicator on how accurate the matching of the user stay and the POI is. The larger the confidence level is, the more accurate the matching is. For an embodiment, the confidence score is normalized to a number from 0 to 1, wherein 1 is the normalized score indicating the most confidence. For at least some embodiments, the confidence level is based on the difference of the ranking scores between the selected POI and the second best POI. If the difference is too small, the system is not (less) confident. If the difference is large enough, the system is confident.

For at least some embodiments, the parameters for each POI include at least one of a physical distance between the POI and the user stay, an edit distance between an address of the POI and an address of the user stay, a timing of the POI in comparison to timing of the user stay, a motion pattern associated with the POI in comparison to motion of the user stay, and/or a popularity of the POI.

For an embodiment, the ranking scoring is additionally influenced by personal places of a user of a mobile device associated with the user stay. For an embodiment, the personal places includes at least one of home/work of the user, prior user corrected POI, number of previous visits by the user, context information of the user, such as, internet or location searches by the user.

For an embodiment, the ranking scoring is additionally adjusted by the size of the POI based on big or small POI heuristic of importance. For example, if POIs around a user stay includes big POIs such as grocery store, supermarket, department store, airport, or hotel, and small POIs such as ATM. At least some embodiments include measuring distances from the centroid of the user stay to the centroid of POIs. The distance to big POIs may be larger than the distance to small POIs only because the big POIs are larger. A user who is in a department store may have a user stay closer to an ATM. At least some embodiments include favoring large POIs in this case. Therefore, the ranking scores of large POIs are adjusted by multiplying a factor less than 1.

As described, at least some of the disclosed embodiments use mobile location information as well as other user-related context information to compute a score and rank potentially visited POIs. When user arrives at a place and stays there for certain period of time, it is defined as a user stay. As described, the user stay usually includes a start time, an end time and a representative centroid point. For at least some embodiments, spatial information is available, for example, from GPS or network location system for each user stay as well as user's motion state information, such as stationary, walking, driving inferred from motion sensor data during this user stay. Based on the location centroid, a list of nearby POIs can be obtained after querying geo-database, each of which is viewed as a public POI candidate. For at least some embodiments, users can add their personal places like home and work, which are personal POI candidates. For an embodiment, users can make corrections for wrongly selected POIs, which are user-corrected personal places. For an embodiment, each POI candidate includes the following information components or parameters (name, address, latitude, longitude, category), available from most geo-databases. For an embodiment, at least some POIs have additional information (or parameters) such as business hours, number of reviews, ratings, check-ins etc.

For at least some embodiments, the following user-related information metrics are calculated between the ith POI and the user stay:

Place Distance d_i

For an embodiment, the physical distance is the distance between an estimated location of the user stay and the location associated with the POI. For an embodiment, the physical distance between the POI and the user stay has a greatest weighting. For an embodiment, the place distance d_i is defined as the physical distance between the location centroid of the user stay and the location point of each POI candidate. For this embodiment, the POI candidate with lowest physical distance is likely to be ranked higher.

Edit Distance e_i

For an embodiment, the edit distance e_i is defined as the normalized edit distance between user stay's street address and each POI candidate's street address. It handles street abbreviations. For example, the normalized edit distance between user stay “1032 Elwell Court” and one POI candidate “1007 Elwell Court” is 2/17, while the normalized edit distance between user stay “1032 Elwell Court” and one POI candidate “1032 Elwell Ct” is 0.

Time of Day and Day of Week t_i

An embodiment includes comparing the timing of the POI to timing of the user stay. For an embodiment, the timing of the POI includes general business hours based on the POI's category or hours of operation of the POI.

For an embodiment, the time of day and day of week t_i of the time based feature provides a correlation coefficient between the user stay's (start, end) time and each candidate POI's category. For each category, we define its regular open hours and busy hours based on common knowledge. If a candidate POI provides a specific business hour on time of day and day of week, we compare it with the (start, end) time of user stay to decide whether it is open or closed. If it is closed, the score is zero. For example, the personal POI with “Work” category will be given high score during 9 am-5 pm work hours and it will receive reduced score for the other time of the day.

Motion Heuristic m_i

An embodiment includes motion states, where the motion states between the start time and end time of the user stay provides motion pattern of the user with that place. The motion states can be used to correlate with each candidate's category as an empirical score. For example, the motion states can be a sum-up movement number of all motion states or percentage distribution of motion states (stationary, walking, driving, unknown). For example, if the movement number is low which means user is stationary, the POI in “Restaurant” category is given a high score while the POI in “Grocery stores” category is given a low score. For an embodiment, the ranking score is additionally influenced by whether a motion pattern of the user stay matches a motion pattern of the POI based on a category of the POI.

Place Popularity p_i

For an embodiment, the popularity of the POI includes at least one of a number of reviews and ratings of the POI, a number of check-ins associated with the POI. For an embodiment, the popularity of the POI includes at least one of a number of reviews and ratings of the POI, a number of check-ins associated with the POI. For at least some embodiments, different POIs have different popularity scores, which can be number of reviews times number of ratings divided by a constant, or number of user check-ins divided by a constant.

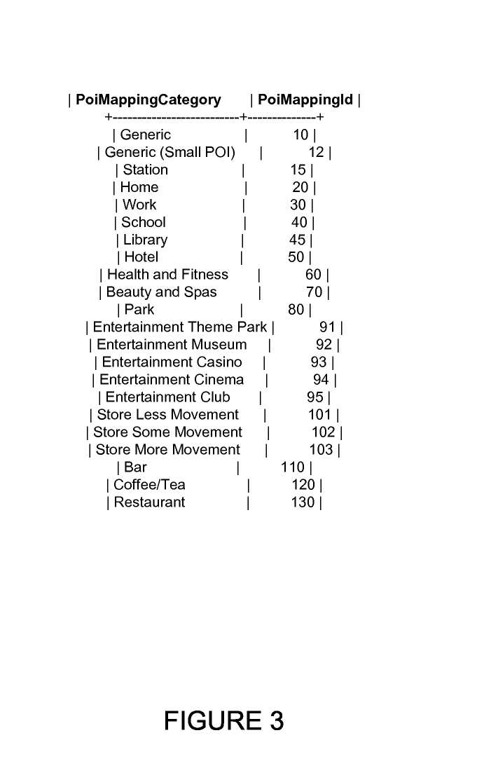

FIG. 3 is a table that shows a mapping of all POI categories category classes based on properties of the POIs, wherein a POI mapping ID is assigned to each POI category, according to an embodiment. Based on each POI mapping ID, default open hours for time of day and each day of week for each of the POI categories is listed, which is usually available from websites. Based on user's motion pattern, the POI categories are categorized into mostly stationary, mostly moving, half stationary and half moving or unknown, and correlate them with the POI mapping category ID by a score between 0 and 1.

For at least some embodiments, the POI ranking score of each POI candidate is calculated by this formula:

R_{—}i=[d_{—}i*f(e_{—}i)*w_{—}i]/[(c1+t_{—}i)*(c2+m_{—}t)*(c3+p_{—}i)]

where f(.) is a function of edit distance as defined below, and c1, c2 and c3 are weighting constants to balance the final score. The smaller the score is, the more relevant the POI is.

For at least some embodiments, the POI ranking score processing iterates with each POI candidate according to the following procedures.

First, the processing calculates the physical distance d_i between the ith POI candidate and the user stay centroid, where d_i is defined as Euclidean distance between two geographical points with coordinates (latitude, longitude).

Next, the processing calculates the edit distance e_i between user stay address and POI candidate address, normalized by the length of the longer one (longest distance) between the user stay address and the POI candidate address.
If e_i is equal to 0, it means two addresses match exactly, and set f(e_i)=0.5;
else if 0<e_i<0.3, we set f(e_i)=1+e_i;
else, we set f(e_i)=1.3.

Next, the processing calculates the time score t_i based on the (start, end) time of the user stay falling into defined open hour interval according to its category, it is a normalized score between 0 and 1. If one POI provides a specific business hour, calculate the open score based on the (start, end) time of the user stay falling into this specific hour interval, normalized between 0 and 1, and multiply t_i by this open score

Next, the processing calculates the motion heuristic score m_i by looking up the pre-defined correlation table between motion pattern class and POI mapping category ID.

Next, the processing calculates the popularity score p_i as:

p_{—}i=number of reviews*number of ratings/scaling number;

p_{—}i=number of check-ins/scaling number;

Set a cap for popularity, such as if p_{—}i>threshold, p_{—}i=threshold

For at least some embodiments, the ranking score R_i is further adjusted depending on whether the user stay is within the boundary of the POI, if the boundary of the POI is available. For at least some embodiments, the boundary of a POI is represented by a polygon, where each vertex of the polygon is specified by a location point. At least some embodiments include favoring (better ranking) POIs whose boundaries the user stay is within. That is, for an embodiment, if the user stay is within the boundary of a POI, the ranking score of the POI is adjusted to smaller.

For at least some embodiments, the ranking score R_i is further adjusted by whether the wireless signature of the user stay matches a wireless signature associated with the POI. That is, the mobile device can detect wireless signatures, which are represented by a series of MAC, SSID, and RSSI, for location points. At least some embodiments include building up a POI database for POIs of those user stays confirmed by users. The database contains the mapping from POIs to the wireless signatures detected at the corresponding user stays. Accordingly, at least some embodiments include identifying if a new user stay is at a POI by matching the wireless signature of the new user stay with the wireless signature of the POI.

For at least some embodiments, the ranking score R_i is further adjusted by determining whether the wireless SSID detected at the user stay matches the name of a POI. In some situations, the SSID contains the name or acronym of the name of a POI. Some chain stores may use the same SSID or SSIDs in similar patterns in all stores. If the SSID detected at the user stay matches a POI, an embodiment includes adjusting R_i to a smaller value to favor (improve the ranking of) the POI.

For at least some embodiments, the ranking score R_i is further adjusted by a combined factor of w_i. For at least some embodiments, if the POI includes user added personal places such as home or work or user corrected places, multiply R_i by a snapping factor which is a curve function of distance itself and place type. For at least some embodiments, if the POI has been visited before by the user, multiply R_i by a factor that is proportional to number of visits. For at least some embodiments, if the POI has been appeared as context information available from the user or searched by the user, multiply R_i by a snapping factor of context association. For at least some embodiments, if the POI's category shows it has a large size, such as grocery store, supermarket or department store, airport, hotel, we detect whether there are other POIs around sharing the same location or address and decide to multiply R_i by a snapping factor of big POI heuristic importance. On the other hand, if the POI's category shows small size and less importance, such as ATM or contractor, we enlarge R_i by a factor of small POI heuristic.

For at least some embodiments, after obtaining the scores of all POI candidates, the POI candidates are ranked in an increasing order, such as R_1, R_2, R_3, . . . , R_N. Based on ordered statistics, it is decide whether R_1 is significantly lower than R_2 and R_3 and indicate whether the POI selection is confident or not by taking into account their physical distances and the fact that the selected place is personal or not.

Referring back to FIG. 2, signals sensed by a motion sensor (for example, an accelerometer) 240 can be used to provide additional user-related information. That is, for example, the GPS 220 may be precise enough to narrow down the identification of a location of interest to three businesses. The signals generated by the motion sensor 240 can provide an indication of activity of the user, which can be used to additionally identify a location of interest. For example, when a department store (e.g. Walmart®) is located next to a cafe (e.g. Starbucks®), the user's motion pattern can be used to disambiguate between the two POI (points of interest), Walmart and Starbucks. If the user's motion pattern indicates that the user has been walking around most of the time, then the probability that the user visited the department store is higher. On the other hand, if the user's motion pattern indicates that the user has been sitting still most of the time, then the probability that the user visited the cafe is higher.

Images captured by a camera 230 of the mobile device 200 can be used to provide additional user-related information. That is, for example, signs on business proximate to the user's location can be used to determined points of interest.

Audio signals sensed by a microphone 250 of the mobile device 200 can be used to provide additional user-related information. That is, for example, loud noise versus quiet noise in the background of a user's location can be used to aid in determination of points of interest. For example, because the noise level in a library is usually low, if the noise level is low, then the probability that the user is in a library is higher than the probability that user is in a restaurant.

Direction of the user can be determined by, for example, a compass 270 of the mobile device 200. The compass 270 can provide present or historical directions of the user. The directions of the user can be used to aid in the determination of points of interest.

Rotation of the user can be determined by, for example, a gyroscope 272 of the mobile device 200. The gyroscope 272 can provide present or historical rotation of the mobile device of that the user carries. The rotation of the mobile device of the user can be used to aid in the determination of points of interest.

An ambient temperature of the user can be determined by, for example, a thermometer 274 of the mobile device 200. The thermometer 274 can provide present or historical ambient temperatures of the user. The temperature of the user can be used to aid in the determination of points of interest. For example, temperature can be used to determined whether the user is or was outside versus inside.

Exposure to ambient light by the user can be determined by, for example, a light sensor 276 of the mobile device 200. The light sensor 276 can provide present or historical light exposure of the user. The light exposure of the user can be used to aid in the determination of points of interest. For example, sensed levels of IR can be used to determine whether the mobile device of the user is, for example, in the user's pocket, and to determine whether the user is in direct sun light.

User-input information can be received from a key-board or touch screen 282. Based on a determination that the user is using the input (key-board or touch screen) behavior if the user can be inferred, and therefore, educated guesses can be made regarding the location of the user. For example, if the user is inputting information, the user is probably not driving. If the user is talking, the user is probably not at a movie theater.

Barometric information from a barometric sensor 284 can be sensed and used to determine user-related information. For example, the barometric information can be used to deduce an altitude of the user, and therefore, be used to determine what floor of a building the user is presently located. GPS can be inaccurate inside of buildings, and therefore, barometric information can be very useful.

A network 290 that the mobile device 200 is connected to, can provide additional user-related information. For example, a server 280 of the network can have street view images that provide additional information regarding a general location that a user is at. The connection to the remote server 280 is optional, because the mobile device may be disconnected from the server. In addition, part of the user profile 260 computation can be performed on the mobile device, and may not be required to be run on the server.

It is to be understood that the processing of the described embodiments for determining user stays and ranking potential points of interest (POIs) can occur at the controller 210, at the network server 280, or at a combination of both the controller 210 and the network server 280. If the connection of the network 290 allows the location information to be properly uploaded to the network server 280, then nearly all of the user stay processing and ranking potential points of interest (POIs) can occur at the network server. However, if the connection of the network 290 is not available, at least a portion of the user stay and ranking potential points of interest (POIs) processing can occur at the controller 210 of the mobile device 200.

For at least some embodiments, one or more of the sensed states of a combination of the sensed states of the described sensors (220, 230, 240, 250, 270, 272, 274, 276, 282, 284) and/or network connectivity (290) are used in user stay and ranking potential points of interest (POIs) determination. The sensed states of the sensors change over time. For an embodiment, patterns or a series of patterns in the one or more sensed states of the described sensors can be identified and/or recognized. For at least some embodiments, changes in the patterns indicate the user is arriving (start time) or departing (end time) a POI, or that the user is in transit between users stays or POIs. Therefore, for at least some embodiments, the information of the sensed states of the sensors can be used to determine user stays. For example, if the motion state (240) indicates that the user is stationary over a period of time, for at least some embodiments, this is used to identify the period of time as a potential user stay. If the network (290) is connected to a wireless station for a period of time, for at least some embodiments, this is used to identify the period of time as potential user stay. If a sensed light intensity of the light sensor 276 of the mobile device maintains a constant level (the same) of sensed light for a period of time, this information can be used to indicate a user stay. If the sensed temperature maintains the same level for a period of time, that information can be used to indicate a user stay.

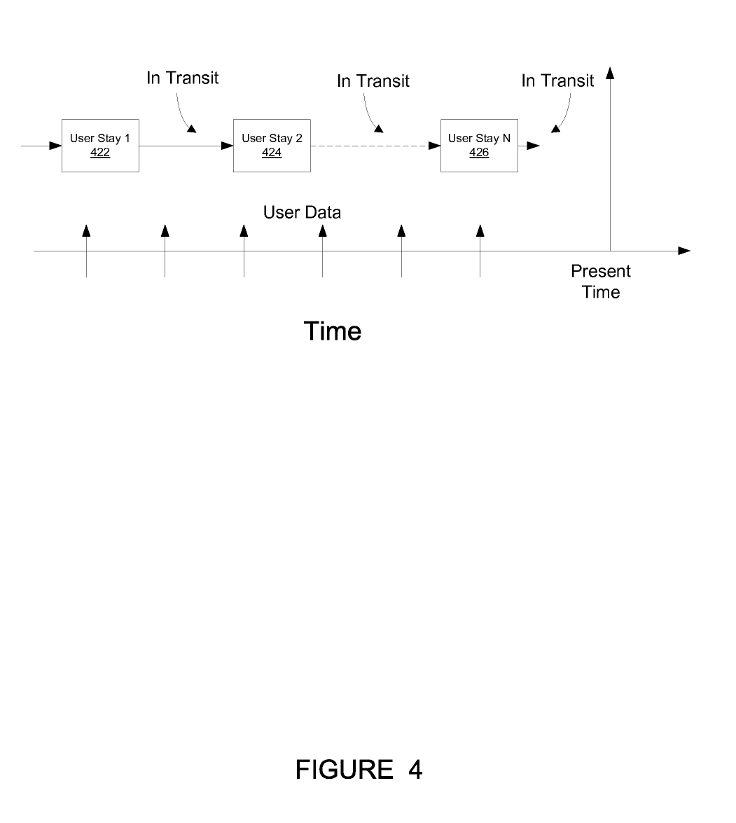

FIG. 4 shows a time-line of locations of the mobile device, which can be used for determining user stays of the user of the mobile device, according to an embodiment. As shown, a sequence of user stays 422, 424, 426 are identified based on location data sensed by the mobile device while the mobile device and the user of the mobile device are in transit.

As shown, user data (including at least location data) is sensed over time. As will be described, based on the user data, user stays are identified. As shown, user stays are typically separated by “in transit” times, wherein the user is in transit between user stays.

Once a user stay is detected, events can be triggered on the mobile device, remote network, or other mobile devices. For example, for at least some embodiments, once the mobile device arrives at a POI or departs from a POI as determined by the detected user stays, a SMS message, a push notification, or an email is sent to other mobile devices that have subscribed to be notified by this type of user stay detection event. For at least some embodiments, detected user stays are organized and saved as a journal of places that have been visited. For at least some embodiments, detected user stays are shared or published in social networks. For at least some embodiments, user stays detected from multiple users are used to detect if the users (that is, multiple connected users) have been at the same place. User stays generated by massive numbers of users can be used to trace the propagation of infectious disease among the users.

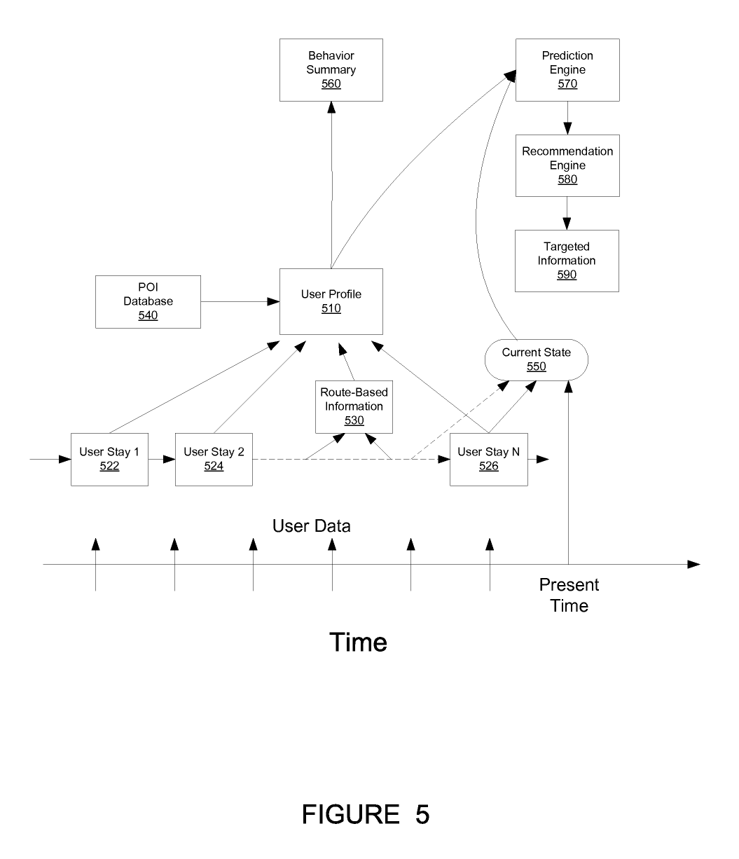

FIG. 5 shows a time-line of user stays of the mobile device, which can be used for providing services to the user of the mobile device, according to an embodiment. The previously described user stays (such as, user stays 522, 524, 526) are generated over time by the historical user location data, in which, for at least some embodiments, each is referenced to a POI in a POI database 540. Route-based information 530 can be inferred from historical commuting behavior of the user moving from one POI to another POI. Embodiments includes a user profile 510 that is generated and continuously updated based on, for example, POIs from a POI database 540, the user stays 522, 524, 526 and route-based information 530. A user profile is generated by analyzing all user stays of the user and extracting user behavior patterns. The user profile 510 can be used to generate a behavior summary 560 of the user of the mobile device. Behavior summary of a user can be created based on the user profile, at a daily, weekly, monthly or yearly basis.

In addition to the user profile 510, embodiments further include determining a current state 550 of the user of the mobile device. As shown, an embodiment of the current state is based upon current user stay information 526 and/or recent user stays, and current user data.

Based on the user profile 510 and the current state 550, predictions of the behavior of the user can be made by, for example, a prediction engine 570. Prediction engine 570 takes static inputs from the user profile 510, such as frequently visited POIs and transitional patterns between POIs, and dynamic inputs from the current state 550 to infer the routes the user may take and POIs the user may visit in the future. Based on the predicted behavior, recommendation can be provided to the user via recommendation engine 580 and targeted information 590 can be provided to the user of the mobile device. The prediction engine 570 can be disabled so that the recommendation engine 580 can make targeted information based on the user profile 510 and the current state 550 directly.

An embodiment includes tracking a current state of the user. For embodiments, the current state includes user stays within a predetermined time of a present time, wherein the predetermined time is dependent upon an application of the user device or an observed behavior of a user of the user device.

For at least some embodiments the user profile includes a history of the user stays of the user. For an embodiment, the user stay includes the point of interest the user has visited, an arrival time and a length of time the user stays at the point of interest.

At least some embodiments further include determining route-based information. Further, embodiments include updating a current state of the user based on the route-based information. Another embodiment further includes predicting future user stays based on the route-based information. Embodiments of determining route-based information include determining a plurality of points of interest, wherein the plurality of points of interest define a trail of interest of the user. As previously described, an embodiment a trail of interest is defined by a plurality of points of interest of the user. For an embodiment, a frequency and/or speed of the user between points of interest is used to determine a level of importance of the trail.

At least some embodiments further include providing the user with targeted information base on the user profile. For specific embodiments, the targeted information includes at least one of coupons, advertisement, notices of events. Other embodiments include estimating a likelihood of conversion of targeted advertising based on the user profile, and/or measuring a conversion of targeted advertising based on the user profile. Additionally, a rewards-based program can be facilitated based on the user profile. That is, visits to a merchant can be monitored, and rewards automatically applied based on visits to the merchant.

For an embodiment, the user profile is supplemented based at least in part on websites visited by the user. For one implementation further includes supplementing the user profile based on information posted by the user on at least one of the websites. For another implementation, at least one of the websites comprises a social website.

Embodiments include providing the user with suggestions. For example, one embodiment includes providing the user with at least one suggestion based on identified points of interest. Another embodiment includes providing the user with at least one suggestion based on at least one predicated future point of interest. Further, embodiments include modifying (including changing or removing) a suggestion based on the user location history and user profile.

For at least some exemplary embodiments, route-based information is defined as the name of each route a user takes, the route usage frequency, the time when the route is usually taken, and the general speed information on the route.

Embodiments include a prediction engine that processes dynamic inputs from the user profile of a user and current state of the user to infer future POIs the user may visit and the routes the user may take. The prediction results can be used for providing targeted information to the user.

Once the profile has been created, the user can be provided with targeted information based on the user profile. Additionally or alternatively, a likelihood of confirmation of targeted advertising based on the user profile can be estimated. Additionally, the user profile can be supplemented based at least in part on websites visited by the user.

Embodiments include providing the user with at least one suggestion based on the identified points of interest. For an embodiment, this includes providing the user with at least one suggestion based on at least one predicated future point of interest. For an embodiment, a suggestion is modified based on the user profile. For example, a user profile could be used to determine that a user has already satisfied the condition of the suggestion because profile of the user suggests the user has already visited the appropriate location. Clearly, modifying can include changing or removing the suggestion.

As an example of the use of suggestions, a user's shopping list can be tracked, and the items on the shopping list can be correlated with the shops (special POIs) the user usually visits. When the user is physically close to a shop that has one or more items on the user's shopping list, a suggestion can be generated to remind the user to stop by the shop to purchase the item.

After such a suggestion is generated, the mobile device monitors the user's location history, and if it detects that the user stops at the specific shop, where a specific item on the shopping list has been in one of the suggestions presented to the user, the system can automatically remove the specific items, or reduce the priorities of those items.

Examples of intelligent personal services include spatial suggestions. An exemplary spatial suggestion includes a reminder to a user of a mobile device that is based on spatial information of the mobile device. Reminders include suggestions that are useful to the user. Intelligent personal services include, for example, making health-related suggestions, such as doing more physical activities (e.g. walking) than sitting still. Embodiments of personal services include providing recommendations or suggestions to the user based on the user's habits and interests, for example, kid-centric events during a weekend for people with children. Services can also include commercial services, such as recommending a cheaper gas station near the user's regular commute route.

Location based user behavior analysis can also be useful to a mobile advertiser. For example, after a mobile advertiser has displayed an advertisement to a user, the advertiser would like to determine if the user has been to the merchant in the advertisement and conducted business, and determine if the advertisement has been confirmed. Additionally, advertisers desire user profile information, which enables the advertiser to intelligently send targeted advertisements.

When, for example, the system detects that the user often goes to an elementary school or a child day care center, the system infers that the user may have one or more children, then the system may generate targeted information to the user for child-related events.

After the system detects the user usually go to a local public library on Saturday morning, the system can automatically generate a suggestion on Saturday morning when the user leaves home to remind the user to bring the books to return to the library.

The system tracks when the user gets gasoline for his car, and tracks the number of miles the user has driven the car after each refill. When the system detects that the user has used most of the gasoline in his tank based on the number of miles driven and the speed, as a result of the road type, such as local streets or high ways, the system can start to find gas station with low prices and make targeted information to the user.

Real-Time Determination of User Stays

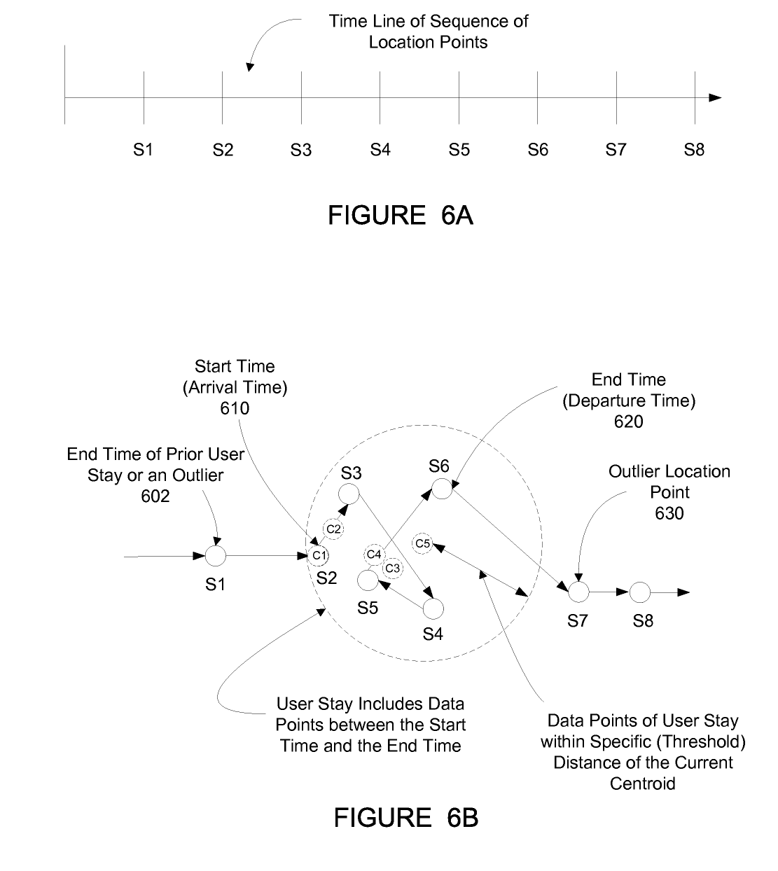

FIG. 6A shows a time-line of location points, according to an embodiment. While the location points 51, S2, S3, S4, S5, S6, S7 are shown evenly spaced in time, it is to be understood that at least some embodiments include the location points evenly spaced in time, while other embodiments do not include the location points being evenly spaced in time. That is, for at least some embodiments, the location point samples are periodic, while for at least some embodiments the location point samples are triggered, or otherwise non-periodic.

FIG. 6B shows a spatial and temporal representation of the location points S1, S2, S3, S4, S5, S6, S7, according to an embodiment. Further, FIG. 6B shows real-time representations of calculations of a current centroid (C1, C2, C3, C4, C5). Each current centroid is calculated based on the location data of the start time (such as, location point S2 610), and subsequent location data, until an end time (such as, location point S6 620). That is, with the determination of each successive location point S1, S2, S3, S4, S5, S6, S7, the current centroid is updated, or recalculated, until the end time.

Start Time of Real-Time User Stay Determination

For an embodiment, the start time of the real-time determined user stay is determined as being separate from a prior user stay. For example, S1 602 can be the end time of a prior user stay, or a transitory location point that is not included within any user stay. For an embodiment, the start time is determined as a location point that is an outlier of a prior user stay. For an embodiment, an outlier is a location point that is located outside of a distance threshold from a current centroid. For an embodiment, the start time is a first location point after, for example, the mobile device has been turned on, or location points have just started to be sensed.

Current Centroid of Real-Time User Stay Determination

Once a start time has been identified, a current centroid is calculated based on the location point of the start time, and subsequent location points. For example, a current centroid C1 is determined based on the start time S2 610. Further, upon generation of the next location point S3, a new current centroid C2 is calculated or determined based on the location point S2 of the start time, and the current location point S3. Further, upon generation of the next location point S4, a new current centroid C3 is calculated or determined based on the location point S2 of the start time, the location point S3, and the current location point S4. Further, upon generation of the next location point S5, a new current centroid C4 is calculated or determined based on the location point S2 of the start time, the location point S3, the location point S4, and the current location point S5. As depicted, with each new location point, the currently determined centroid changes position as determined by a statistical estimation or calculation based on the location point of the start time, and subsequent location points of the current user stay.

End Time of Real-Time User Stay Determination

For an embodiment, the user stay includes the location point of the start time, and subsequent location points that are within a threshold distance of the currently calculated or determined centroid. Once a location point is received or determined that falls outside of the threshold distance from the current centroid, for an embodiment, the user stay is terminated. That is, it is determined that the mobile device has physically moved outside of the current user stay, and the current user stay is terminated. For example, location point S7 is greater than the threshold distance away from the current centroid C5. Therefore, the prior location point S6 is determined to be at the end time of the user stay. Further, the location points S2-S6 are determined to be within the user stay, and the location point S7 630 is determined to be an outlier location point. Location point S7 can then be determined to be a transitory location point, or may be determined to be the start time location point of a subsequent user stay.

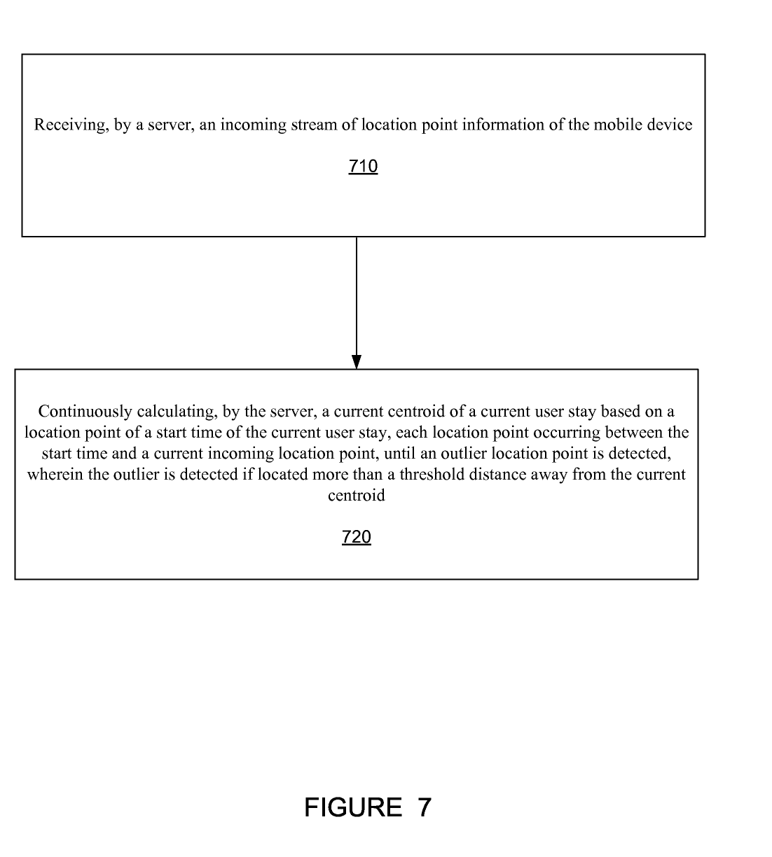

FIG. 7 is a flow chart that includes steps of an example of a computer-implemented method of real-time determination of user stays of a mobile device, according to an embodiment. A first step 710 includes receiving, by a server, an incoming stream of location point information of the mobile device. For an embodiment, the stream of location point information is sensed by the mobile device. As previously described, for at least some embodiments, the mobile device is electronically connected (wireless and/or wired network connections) to the server (also referred to as the upstream server). A second step 720 includes continuously calculating, by the server, a current centroid of a current user stay based on a location point of a start time of the current user stay, each location point occurring between the start time and a current incoming location point, until an outlier location point is detected, wherein the outlier is detected if located more than a threshold distance away from the current centroid. It is to be understood that the mobile device includes a controller and the server includes a controller. For at least some embodiments, the continuous calculating of the current centroid can be performed entirely by the controller of the server. For at least some embodiments, the continuous calculating of the current centroid can be performed entirely by the controller of the mobile device. For at least some embodiments, the continuous calculating of the current centroid can be performed at least partially by the controller of the mobile device and at least partially by the controller of the server.

For an embodiment, the start time includes a prior outlier location point or the first data location point after the mobile device is powered up. For an embodiment, each start time is a potential start time of a potential user stay. Once a user stay is validated, the potential start time is confirmed as the start time of a valid user stay. For an embodiment, valid user stay is a user stay with duration larger than a threshold. That is, a user stay at a POI location will have a minimum time duration in which the user is within the user stay. If less than the minimum, the user stay is invalidated.

For an embodiment, the location point information comprises a timestamp, latitude, longitude, and a location type (the location type can include, for example, GPS location point information or network location point information). For at least some embodiments, the location point information additionally or alternatively includes motion state information, location point accuracy information, speed information, and/or GPS state information. For an embodiment, the motion state information is used for invalidating user stays. For example, for a user stay that consists of a few location points, and a motion state indicates the user is in driving mode, the user stay is determined not a valid user stay because the mobile device is moving. Further, a determined speed of the mobile device can alternatively be used to invalidate user stays. That is, if the mobile device is determined to be moving faster than a threshold speed, the current user stay can be invalidated. For an embodiment, a user stay is validated if the user stay includes duration larger than a threshold. Here, embodiments includes extra information (motion, speed) to further filter user stays that were previously validated, and then invalidates the user stays based on the motion or speed information of the mobile device.

For an embodiment, the location information includes at least one of GPS data or network location data. For at least some embodiments, the determined or assumed accuracy of the location point information is used for filtering the location point information and/or for classifying the location point information. For at least some embodiments, accuracy of the location point information is assumed to be better if the location point information is GPS location information. However, for at least some embodiment, the location point information is assumed to be better if the location point information is network location information.

As previously shown and described in FIG. 2, the mobile device includes many possible sensors. Any combination of the sensed information can be used for location determination, and current user stay determination. The sensed information of each of the sensors of the mobile device can be used to at least partially influence the determination of the current start time, the current centroid and/or the current end time.

An embodiment further includes filtering the incoming stream of location point information before continuously calculating the current centroid of the current user stay. At least some embodiments include filtering the stream of location points. For at least some embodiments, the filtering includes removing location data points that deviate to such a large extent (greater than a large threshold distance) that they cannot possibly be used for location analysis. Further, for at least some embodiments, the filtering includes removing redundant data. At least some embodiments include filtering (removing) low accuracy location point information. For at least some embodiments, the accuracy is obtained from mobile device. The location data points can be classified as high or low accuracy points. For example, for an embodiment, low accuracy location points are data points with accuracy threshold larger than a threshold distance, such as, 200 meters.

An embodiment further includes receiving additional location point information, and re-calculating the current centroid continuously with the additional location point information if location points of the additional location point information are within the threshold distance of the currently calculated centroid.

An embodiment includes maintaining the start time of the current user stay, wherein the start time comprises the time stamp of the first location point of current user stay.

An embodiment further includes continuously updating an end time of the current user stay with the current incoming location point until the outlier location point is detected.

An embodiment further includes restarting calculation of the current centroid using a new start time after the outlier location point is detected.

An embodiment further includes using network location points between a most recent location point inside the current user stay and a first location point outside the user stay to adjust the end time based on GPS state information and distance of network location points to the centroid of the user stay less than a threshold.

For at least some embodiments, network location data points with good accuracy are used instead of GPS data points for calculating centroid and outlier. For at least some embodiments, network location points with low accuracy are used for supplementing end time calculation. For example, in FIG. 6B, a network location data point with low accuracy between S6 and S7 can be used to adjust the end time from S6 to this network location data point.

An embodiment further includes validating the current user stay by confirming a time duration of the current user stay is greater than a time threshold. That is, most user stays are observed and associated with a POI. Accordingly, the current user stay can be validated by having a time duration greater than a minimum amount of time. For at least some embodiments, the time duration threshold is selected based on statistics of user stays and associated POIs. Further, for at least some embodiments, the time duration threshold adaptively changes based on candidate POIs associated with the user stay.

For an embodiment, the threshold distance is adaptively changing based on an estimated size of the current user stay. For an embodiment, the distance threshold is set in a coarse level first to detect user stay at a large scale, and then repeat in a fine level to extract user stays at a small scale.

For an embodiment, the distance threshold is adaptively updated based on a candidate point of interest (POI) of the current user stay. For example, the threshold for a park can be selected to be 1000 meters, whereas for POIs within the park, the threshold can be defined as 100 meters, for example, for a Café in the Park.

For an embodiment, the mobile device comprises a mobile device processor, and an upstream server electronically connected to the mobile device comprises an upstream server processor, and wherein at least one of the mobile device processor or the upstream server processor executes the step of calculating the current centroid.

For an embodiment, the current user stay comprises a sub-current user stay, and further comprises continuously calculating a sub-current centroid within the sub-current user stay based on a location point of a sub-start time of the sub-current user stay, each location point occurring between the sub-start time and a current incoming location point, until a sub-outlier location point is detected, wherein the sub-outlier is detected if located more than a sub-threshold distance away from the sub-current centroid. The sub-current user stay can be as described above, physically location within a current user stay.

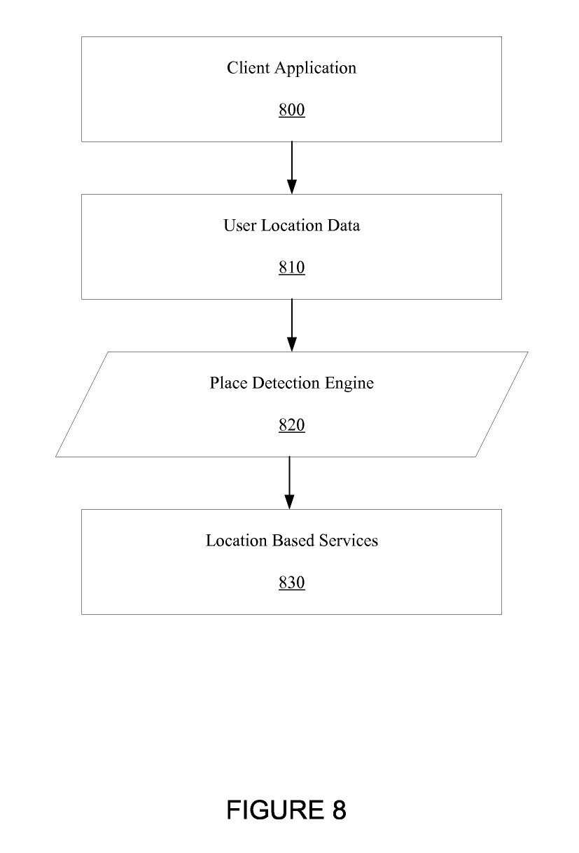

FIG. 8 is a flow chart that includes steps of a continuous place detection engine using location data of a mobile device of a user, according to an embodiment. As shown, a client application 800 collects user location data 810 from one or more location sensors (such as, a GPS sensor of the mobile device) and/or from network assisted location providers, such as Wi-Fi or cellular tower. The input data stream into a place detection engine 820 which outputs a user location centroid and a time interval stayed at each location. For at least some embodiments, this information can be used for various location based services 830, such as local search, POI determination and location based mobile social networks.

For an embodiment, the location data is in the format of data (timestamp, latitude, longitude, accuracy, speed, state, type), where timestamp represents when this data point is recorded, (latitude, longitude) means the exact geographical location of this point on the earth, accuracy means the GPS data quality in a radius of meters, and speed means how fast the GPS point moves. (state, type) means the GPS sensor state (on or off) and data point type (GPS or network). For an embodiment, when and where one user stays for a certain period of time is detected based on these seven components. Further, it is possible to extract out the user stay as a possible location for the user of the mobile device.

For an embodiment, processing at the mobile device, at the network server, or a combination of the mobile device and the network server, starts with the location input data stream and processes the stream according to the timestamp as a multidimensional time series. If the data is not ordered in timestamp, which can happen, an embodiment includes reordering the data stream an increasing order (latest being last) of timestamps.

For the described embodiments, the location data stream is a continuous source of data indexed by timestamp and labeled by accuracy, speed, state and type. For an embodiment, two parameters are used in the detection processing. One parameter includes the minimum time stay (time_stay) required for a point of interest and the other is the radius of place coverage (place_radius). The processing can be described in the following pseudo code:
Reindex the data stream by an incremental array index (ind) starting from one, so that each row can be accessed by data (ind).
Given the values of time_stay and coarse place covering radius place_radius, call the function module to get [time_intervals, places]=Continuous_Refinement (data, stay_time, place_radius). The returned time_intervals includes the start array index, the end array index, the start timestamp, the end timestamp, the time duration of each place detected. The returned places includes the (latitude, longitude) centroid of each place detected.
Given the values of time_stay and fine place covering place place_radius_fine, for each time interval ti discovered in the second step, call the function module to get [fine_time_intervals, fine_places]=Successive_Refinement(data(ti(start):ti(end)), stay_time, place_radius_fine). If the time interval can't be further refined, we put the original time interval ti and places into fine_time_intervals and fine_places. For an embodiment, setting place_radius_fine=place_radius_coarse/2 or place_radius_coarse/4.

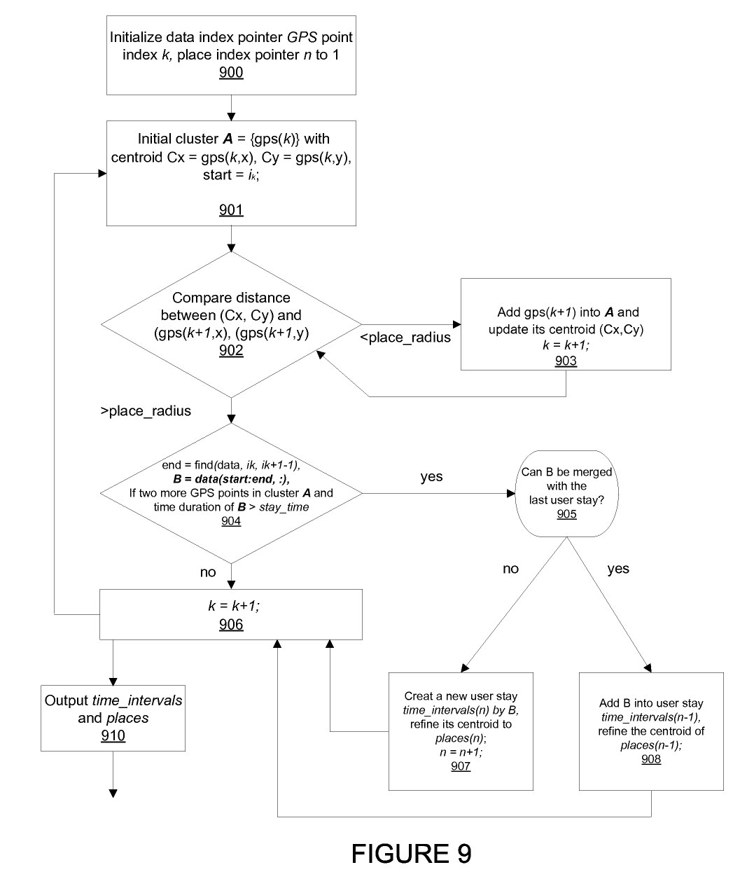

FIG. 9 is a flow chart that includes steps of continuous user stay refinement processing, according to an embodiment. The successive refinement processing repeats the same procedure with a different place radius. The input data stream is first entered into an incremental centroid calculation and clustering, and then check if the discovered time interval satisfies the user stay requirement. If yes, it is determined whether to merge this new user stay with the last one or create a new user stay based on certain spatial and temporal criterion. For an embodiment, the centroid calculation and clustering apply to GPS point only, while the time interval estimation depends both on device GPS points and network returned GPS points. The process continues until the input data stream is consumed out. While described as GPS points, it is to be understood that the processing can be applied to location points that are non-GPS points.

At step 900, an initial data index pointer and place index pointer is set to one, and scanning of the input data stream starts. The GPS point index is k, and its corresponding data index is mapped by i subscript with k. At step 901, the first GPS point is put into the initial cluster as a centroid, and then its distance is compared with the next GPS point at step 902. If the distance is less than the parameter place_radius, this GPS point is added into the cluster and its centroid is updated at step 903. Otherwise, at step 904, the end point from the last GPS point in the cluster is determined until the first GPS point out of the cluster by checking network points in-between less than a distance threshold of centroid and GPS state information. It checks whether the segmentation B satisfies the user stay requirements, such as its time duration is greater than a threshold, there is no high-speed location points and motion states inside the user stay, and the movements between adjacent GPS location points are not along one direction. If no, the process continues to the next GPS point in step 906 and then goes back to unit 901. If yes, a decision is made whether B can be merged with the previous user stay in step 905 by checking the distance between two centroids and time difference between two user stays in step 905. Step 907 and step 908 separately deal with the merging and non-merging cases by refining centroid and extracting the time interval. The process continues to step 906. Further, the step 906 generates output time intervals and places 910.

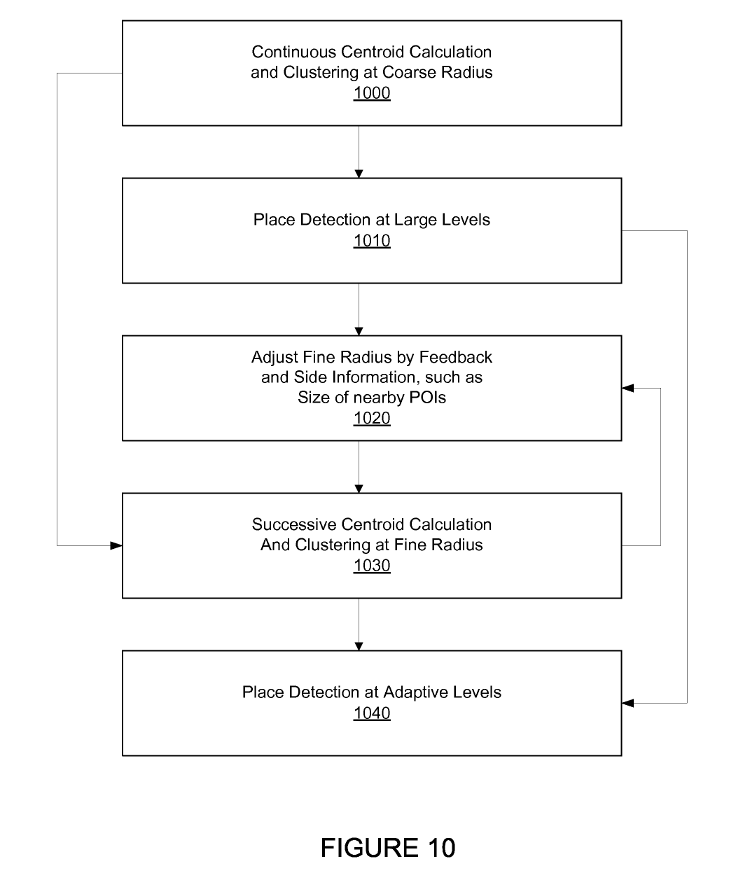

FIG. 10 is a flow chart that includes steps of a method of place detection, according to an embodiment. Step 1000 includes continuous centroid calculation and clustering at a coarse radius. Step 1010 includes place detection at large levels. Step 1020 includes adjusting the fine radius by either feedback information from step 1030 of successive centroid calculation and clustering at predefined radius, or by some side information from the third party, i.e., size of nearby POIs and density of surrounding regions. Step 1030 repeats the same procedure of step 1000 at different radius and may cause different sub-clustering results, which can be compared and further tuned to get better results. Finally, all combined outputs from 1010 and 1030 can generate place detection results adaptively to different region levels 1040, such as big shopping malls, medium supermarkets, and small restaurants.

Various embodiments as described include calculation or determination of a specific location (current centroid). For an embodiment, the specific location is determined based on a statistical analysis of a running set of location data points. Further, the specific distance can be set by a predetermined threshold. Further, the specific minimum duration of time can be set by a predetermined threshold. For at least some embodiment, the threshold of the specific distance and the threshold of the minimum time duration are adaptively selected based on candidate POIs associated with the specific location.

As mobile devices with GPS sensors become increasingly pervasive, it has become very useful to track a user of a mobile device and determine where the user has spent time during, for example, a day. The described embodiments acquire a user's location data and automatically detect his places of interest or significance.

For at least some embodiments, user data (including at least location data) is collected by a small program running on the mobile device and transferred in a format of (such as, current time, current location coordinate, estimated accuracy of that location coordinate) as best as can be determined by the mobile device. As described, the location data can include information from cellular and WiFi networks as well as GPS location points. For at least some embodiments, the collected user data is stored in a database, and can be processed later in batch mode.

Place Acquisition

For an embodiment, during place acquisition, the input track points (location data points) are processed, generating a set of user stays including a starting time, a duration, and a centroid point that is centroid of the user stay. Place acquisition includes processing of the input track points first by ordering them according to their time stamps. Outliers due to noise in the location determining devices are removed, and the remaining track points are then sent through a segmenting process. Each candidate user stay produced by segmentation is adjusted in a massaging process. After massaging, smaller segments are filtered out. A centroid for the surviving user stay is computed along with its duration. Finally the user stay is output as detected place results.

For at least some embodiments, outlier removal is performed by fitting an empirical distribution (such as Gaussian) to the data in terms of GPS speed, 2-D spatial location (latitude, longitude), and GPS accuracy. The data points lying outside of a certain range (95^{th} percentile, for instance) will be removed from further analysis. The outliers or series of continuous groups of outliers that are removed are actually summarized and attached to the non-outlier point as prefix and suffix.

For an embodiment, a smoothed speed is observed to determine whether it is slow enough. For an embodiment, the smoothed speed at a track point is the average speed of the device as calculated based on GPS distance and time elapsed during a predetermined time interval (such as, 5 minute interval) around each point.

For an embodiment, a bearing deviation is observed to determine whether it is large enough. For an embodiment, the bearing at a track point is the angle between two segments. One segment is from the last track point to North Pole. The other segment is from the last track point to the current track point. The standard deviation of this number during that predetermined time period is the bearing deviation.

For an embodiment, absolute steering is observed to determine whether it is small enough. For an embodiment, the steering is the bearing at the current track point minus the bearing at previous track point. The average of the absolute values of this number during the time window is the absolute steering.

For an embodiment, the leading trail is observed to determine whether it is straight enough. For an embodiment, straightness of the trail is measured by r² from regression where latitude is dependent variable and longitude is independent variable. The closer r² is to zero the straighter the trail is.

For an embodiment, the acceleration at the current track point is approximated by first calculating speed using the distance and time between each track point and the previous track point. The change in speed between the current track point and previous track point is the computed acceleration. The computed accelerations in the past minute is averaged and used as the smoothed acceleration

Centroid Point Calculation

For at least some embodiments, a final step in user stay acquisition is the determination of a centroid point. At least some embodiments include the use of a variety of methods for determining this centroid point to a user stay. Before this centroid point is computed, a filter can be applied to select the points to be included in this calculation. One or more algorithms can be applied to the data points to allow computation of the final centroid point from these filtered points.

For an embodiment, the centroid point to the user stay is computed as coordinate-wise median of the track points remaining after filtering. This is an efficient, robust and effective approximation of the centroid point of each user stay.

For an embodiment, the centroid point to the user stay is computed as coordinate-wise mean of the track points remaining after filtering. This is an efficient, robust and effective approximation of the centroid point of each user stay.

For an embodiment, the centroid point to the user stay is computed as a weighted average of the track points remaining after filtering. For at least some embodiments, the weight given to each track point is computed based on one or more of an accuracy of the location data for this track point, and a state of GPS and location determining device. An embodiment includes a symmetrically decayed weight that falls off as an exponential function of the time from a specified point in time. An embodiment includes determining a time elapsed since or to the absolutely closest time within the user stay whence there is a GPS data point. An embodiment includes determining the linearity of track points immediately preceding and following the current point. An embodiment includes determining the time distance from the chronological center of the current user stay. An embodiment includes determining the time from the current GPS track point to the next GPS track point.

Time Weighted Centroid

At least some embodiments include the calculation of a time weighted centroid. For an embodiment, the centroid of a user stay is calculated by giving a different weight to each GPS point that belongs to the user stay. For an embodiment, the weight for each point is determined by the time duration in which it is believed that the GPS measurement remains valid.

For an embodiment, the weight is assigned as W(n)=T(n+1)−T(n), where T(n) and T(n+1) are the sample time for P(n) and P(n+1), respectively, if a GPS point P(n) is followed by another GPS point P(n+1). For an embodiment, the weight is assigned as W(n)=T_gps_off−T(n), where T_gps_off is the time when client switches to the GPS OFF state, if a GPS point P(n) is the last one for the stay. For an embodiment, the time weighted centroid is calculated as Latitude_of_Centroid=Sum (Latitude(i)*W(i))/Sum(W(i)), and Longitude_of_Centroid=Sum(Longitude(i)*W(i))/Sum(W(i)), where i=0, 1, . . . N.

For an embodiment, the time interval between two GPS points is assigned to the two GPS points equally divided, i.e. half-by-half, if nothing is known about how the GPS points were collected. However, for at least some embodiments, the mobile device (client) avoids collecting location data (such as, GPS samples) unless necessary. Therefore, an embodiment includes weighting to give bias to the GPS sample preceding the time interval.

Ranking POIs Based on Mobile User Data

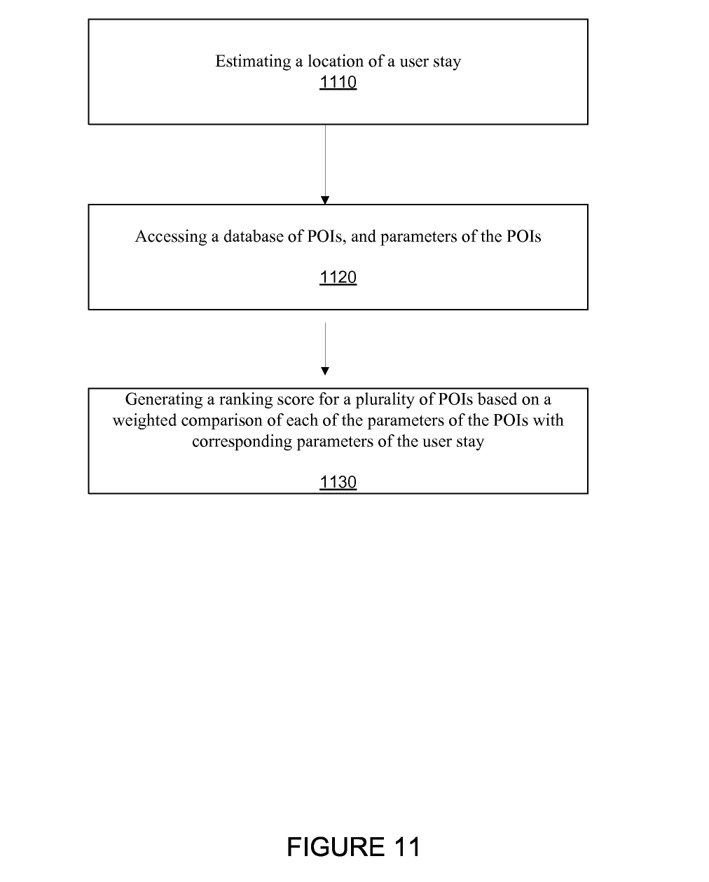

FIG. 11 is a flow chart that includes steps of a method ranking points of interest based on mobile user related date, according to an embodiment. A first step 1110 includes estimating a location of a user stay. A second step 1120 includes accessing a database of POIs, and parameters of the POIs. A third step 1130 includes generating a ranking score for a plurality of POIs based on a weighted comparison of each of the parameters of the POIs with corresponding parameters of the user stay.

Although specific embodiments have been described and illustrated, the embodiments are not to be limited to the specific forms or arrangements of parts so described and illustrated.

1. A system for ranking potential points of interest (POIs) of a user stay, comprising:
an upstream server connected through a network to a mobile device, wherein at least one of the upstream server and a controller of the mobile device is operative to:
estimate a location of a user stay of the mobile device;
access a database of POIs, and parameters of the POIs; and
generate a ranking score for a plurality of POIs based on a weighted comparison of each of the parameters of the POIs with corresponding parameters of the user stay.

2. The system of claim 1, wherein the at least one of the upstream server and the controller of the mobile device is further operative to match the user stay with a POI based on the rankings of the potential POIs with an estimated confidence level of the matching.

3. The system of claim 1, wherein the parameters of the POI comprises at least a physical distance between the POI and the user stay.

4. The system of claim 3, wherein the physical distance between the POI and the user stay has a greatest weighting.

5. The system of claim 1, wherein the parameters of the POI comprises at least an edit distance between an address of the POI and an address of the user stay.

6. The system of claim 1, wherein the ranking score is additionally influenced by whether a wireless signature of the user stay matches a wireless signature associated with the POI.

7. The system of claim 1, wherein the ranking score is additionally influenced by whether an SSID of the user stay matches a name of the POI.

8. The system of claim 1, wherein the ranking score is additionally influenced by whether the user stay is within a boundary of the POI.

9. The system of claim 1, wherein the ranking score is additionally influenced by whether a motion pattern of the user stay matches a motion pattern of the POI based on a category of the POI.

10. The system of claim 2, wherein the parameters for each POI further includes at least one of an edit distance between an address of the POI and an address of the user stay, a timing of the POI in comparison to timing of the user stay, a motion pattern associated with the POI in comparison to motion of the user stay, or a popularity of the POI.

11. The system of claim 10, wherein the timing of the POI comprises general business hours based on the POI's category or hours of operation of the POI.

12. The system of claim 10, wherein the popularity of the POI includes at least one of a number of reviews and ratings of the POI, a number of check-ins associated with the POI.

13. The system of claim 1, wherein the ranking scoring is additionally influenced by personal places of a user of a mobile device associated with the user stay.

14. The system of claim 13, wherein the personal places includes at least one of home/work of the user, prior user corrected POI, number of previous visits by the user, context information of the user, such as, internet or location searches by the user.

15. The system of claim 1, wherein the ranking scoring is additionally adjusted by the size of the POI based on big or small POI heuristic of importance.

16. A method of ranking potential points of interest (POIs) of a user stay, comprising:
estimating a location of a user stay;
accessing a database of POIs, and parameters of the POIs; and
generating a ranking score for a plurality of POIs based on a weighted comparison of each of the parameters of the POIs with corresponding parameters of the user stay.

17. The method of claim 16, wherein the parameters for each POI include at least one of a physical distance between the POI and the user stay, an edit distance between an address of the POI and an address of the user stay, a timing of the POI in comparison to timing of the user stay, a motion pattern associated with the POI in comparison to motion of the user stay, and/or a popularity of the POI.

18. The method of claim 17, wherein the physical distance between the POI and the user stay has the greatest weighting.

19. The method of claim 17, wherein the timing of the POI comprises general business hours based on the POI's category or hours of operation of the POI.

20. The method of claim 17, wherein the popularity of the POI includes at least one of a number of reviews and ratings of the POI, a number of check-ins associated with the POI.

21. The method of claim 16, wherein the ranking scoring is additionally influenced by personal places of a user of a mobile device associated with the user stay.

22. The method of claim 21, wherein the personal places includes at least one of home/work of the user, prior user corrected POI, number of previous visits by the user, context information of the user, such as, internet or location searches by the user.

23. The method of claim 16, wherein the ranking scoring is additionally adjusted by the size of the POI based on big or small POI heuristic of importance.

24. The method of claim 16, further comprising matching the user stay with a POI based on the rankings of the potential POIs with estimated confidence level of the matching.
